(19) United States
(12) Patent Application Publication
(10) Pub. No.: US 2014/0102146 A1
(43) Pub. Date: Apr. 17, 2014

(54) METHOD FOR CUTTING GLASS PLATE

(71) Applicant: ASAHI GLASS COMPANY, LIMITED, Chiyoda-ku (JP)

(72) Inventors: Isao SAITO, Tokyo (JP); Tatsuya Iwasaki, Tokyo (JP); Yusuke Echigo, Tokyo (JP)

(73) Assignee: ASAHI GLASS COMPANY, LIMITED, Chiyoda-ku (JP)

(21) Appl. No.: 14/107,684

(22) Filed: Dec. 16, 2013

Related U.S. Application Data
(63) Continuation of application No. PCT/JP2012/063657, filed on May 28, 2012.

(30) Foreign Application Priority Data
Jun. 15, 2011 (JP) 2011-133548

(51) Int. Cl. C03B 33/09

(52) U.S. Cl. CPC C03B 33/091
USPC 65/112

(57) ABSTRACT

A method for cutting a glass plate includes a first step of radiating a laser beam onto a front surface of the glass plate and forming a crack in the glass plate. The laser beam has a wavelength of 5000-11000 nm and becomes a linear beam at the front surface of the glass plate. The linear beam is formed into a shape conforming to a predetermined cut line, has a length greater than or equal to 10 mm along the predetermined cut line and a width less than or equal to 3 mm, and has an intensity distribution substantially uniform along the predetermined cut line. In the first step, a position of the linear beam in the front surface of the glass plate is fixed for a prescribed time, and at least one end part of the linear beam is located at an outer peripheral part of the glass plate.

### CROSS-REFERENCE TO RELATED APPLICATION

This application is a U.S. continuation application filed under 35 USC 111(a) claiming benefit under 35 USC 120 and 365(c) of PCT application JP2012/063657, filed May 28, 2012, which claims priority to Application Ser. No. 2011-133548, filed in Japan on Jun. 15, 2011. The foregoing applications are hereby incorporated herein by reference.

### TECHNICAL FIELD

The present invention relates to a method for cutting a glass plate.

### BACKGROUND ART

In recent years, cover glass (protective glass) has been widely used in portable devices such as mobile phones and PDAs for enhancing protection of a display (including touch panel) or aesthetics. Further, a glass substrate is widely used as a substrate of a display.

Meanwhile, thickness-reduction and weight-reduction of portable devices is advancing, and thickness-reduction of a glass substrate used for the portable devices is also advancing. Because the strength of glass becomes less as the glass substrate becomes thinner, strengthened glass having strengthened front and back surfaces has been developed for reinforcing the lack of strength of the glass substrate. The strengthened glass is also used for vehicle window glasses and structural window glasses.

The strengthened glass may be, for example, thermally strengthened glass and chemically strengthened glass. The strengthened glass includes front and back surface layers having compressive stress remaining therein. The strengthened glass also includes an intermediate layer, between the front and back surface layers, having tensile stress remaining therein.

In comparison with performing a strengthening process one-by-one on a glass substrate of a product size, it is more efficient to produce a strengthened glass by performing a strengthening process on a glass substrate that is larger than product size, then cutting the glass substrate, and then performing multi-chamfering on the glass substrate.

Thus, as a method for cutting a strengthened glass, there is proposed a cutting method in which cracks are continuously formed with thermal stress by radiating a laser beam on a front surface of a strengthened glass and continuously moving a radiation position (see, for example, Patent Document 1).

### PRIOR ART DOCUMENT

### Patent Document

Patent Document 1: Japanese Laid-Open Patent Publication No. 2008-247732

### DISCLOSURE OF THE INVENTION

### Problems to be Solved by the Invention

With the cutting method disclosed in the above-described Patent Document 1, the strengthened glass has a high absorption coefficient relative to the laser beam and satisfactory heating efficiency. However, the front surface temperature of the strengthened glass easily becomes higher than the internal temperature of the strengthened glass. In addition, it becomes necessary to instantaneously increase the front surface temperature of the strengthened glass at the radiation position of the laser beam because the radiation position of the laser beam is continuously moved.

By instantaneously heating the front surface of the strengthened glass, excessive tensile stress is instantaneously generated inside the strengthened glass, and cracks rapidly propagate in unexpected directions beyond the radiation position of the laser beam. For example, the strengthened glass may be severed at an unexpected area. The strengthened glass may be crushed instead of being cut. This tendency becomes more significant as the tensile stress remaining inside the strengthening glass increases.

In view of the above-described problems, it is an object of the present invention to provide a method of cutting a glass plate that can satisfactorily cut strengthened glass even with, for example, a carbon dioxide gas laser that allows heat to be absorbed at a front surface of glass plate.

### Means of Solving the Problems

In order to solve the above-described object, the present invention provides a method for cutting a glass plate including a first step of radiating a laser beam onto a front surface of a glass plate and forming a crack in the glass plate, the method characterized in that the laser beam having a wavelength of 5000-11000 nm and becoming a linear beam at the front surface of the glass plate, and the linear beam being formed into a shape conforming to a predetermined cut line, having a length greater than or equal to 10 mm along the predetermined cut line and a width less than or equal to 3 mm, and having a intensity distribution that is substantially uniform along the predetermined cut line, wherein in the first step, a position of the linear beam in the front surface of the glass plate is fixed for a prescribed time, and at least one end part of the linear beam is located at an outer peripheral part of the glass plate.

### Effects of the Invention

With the present invention, there can be provided a method for cutting a glass plate that can satisfactorily cut strengthened glass even with, for example, a carbon dioxide gas laser that allows heat to be absorbed at a front surface of glass plate.

### BRIEF DESCRIPTION OF DRAWINGS

FIG. 1 is an explanatory view of a method for cutting a glass plate according to an embodiment of the present invention (1);

FIG. 2 is an explanatory view of a method for cutting a glass plate according to an embodiment of the present invention (2);

FIG. 3 is an explanatory view of a method for cutting a glass plate according to an embodiment of the present invention (3);

FIG. 4 is an explanatory view of a method for cutting a glass plate according to an embodiment of the present invention (4);

FIG. 5 is a schematic diagram illustrating a distribution of residual stress of a glass plate (strengthened glass) in its thickness direction;

FIG. 6 is an explanatory view of an optical system provided between a laser light source and a front surface of a glass plate (1);

FIG. 7 is an explanatory view of an optical system provided between a laser light source and a front surface of a glass plate (2);

FIG. 8 is a diagram illustrating a distribution of intensity of a laser beam at a position along line A-A of FIG. 7;

FIG. 9 is a diagram illustrating a distribution of intensity of a laser beam at a position along line B-B of FIG. 7;

FIG. 10 is a diagram illustrating a distribution of intensity of a laser beam at a position along line C-C of FIG. 7;

FIG. 11 is an explanatory view of an optical system provided between a laser light source and a front surface of a glass plate (3); and

FIG. 12 is an explanatory view of an optical system provided between a laser light source and a front surface of a glass plate (4).

### EMBODIMENTS FOR CARRYING OUT THE INVENTION

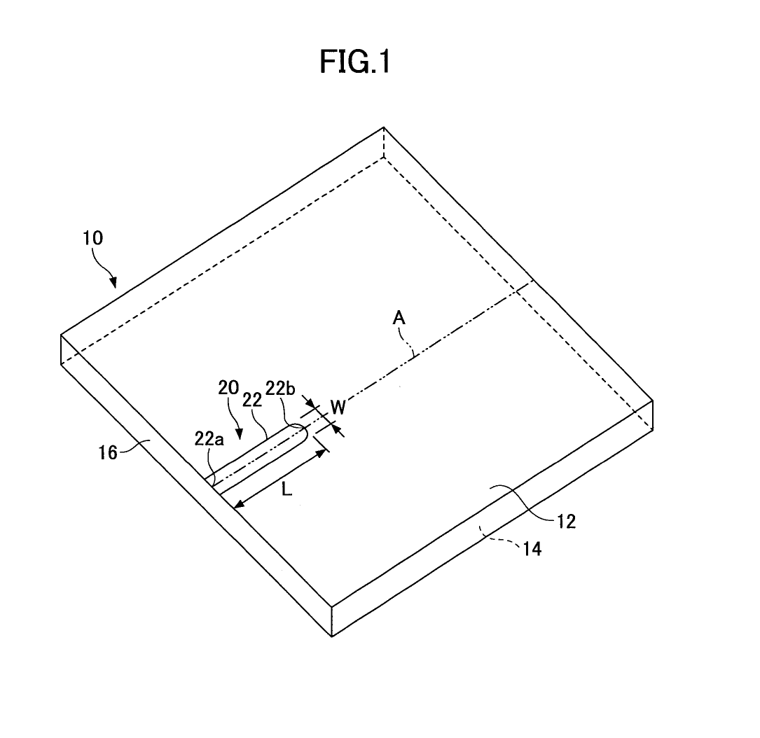

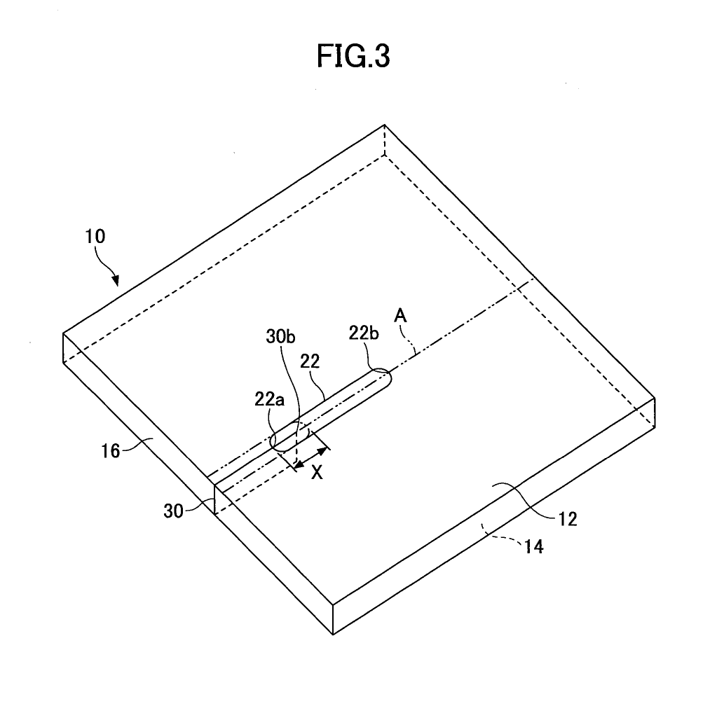

FIGS. 1-4 are explanatory views of a method for cutting a glass plate according to an embodiment of the present invention. In FIG. 3, a laser beam of FIG. 1 is illustrated with a double-dot-dash line.

A strengthened glass is used as a glass plate 10 in this embodiment. The strengthened glass may be, for example, thermally strengthened glass or chemically strengthened glass.

By quenching front and back surfaces of a glass plate having a temperature near a softening point to create a temperature difference between the front/back surfaces of the glass plate and an inside of the glass plate, there can be formed a thermally strengthened glass that includes front and back surface layers having compressive stress remaining therein.

By performing ion exchange at the front and rear surfaces of a glass plate, there can be formed a chemically strengthened glass that includes front and back surface layers having compressive stress remaining therein. The ion exchange is performed on ions included in the glass plate by replacing ions having small ion radius (e.g., Li ions, Na ions) with ions having large ion radius (e.g., K ions). Although the process liquid for the ion exchange is not limited in particular, the process liquid may be, for example, KNO₃ molten salt.

Because the strengthened glass is formed with front and rear surface layers having compressive stress remaining therein, an intermediate layer having tensile stress remaining therein is formed between the front surface layer and the rear surface layer as a counteraction of the forming of the front and rear surface layers.

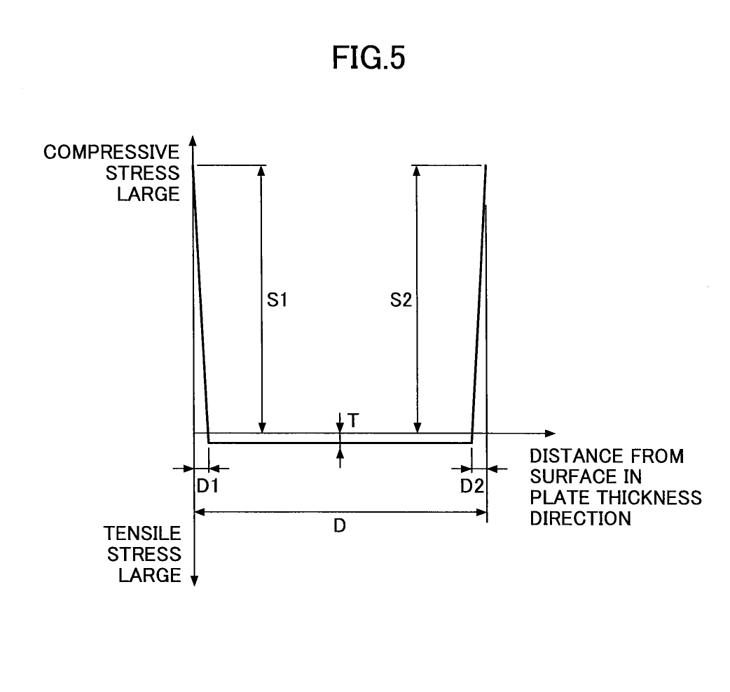

FIG. 5 is a schematic diagram illustrating a distribution of residual stress of the glass plate 10 (strengthened glass) in its thickness direction. As illustrated in FIG. 5, the compressive stress remaining in the front and back surface layers tends to gradually become smaller toward the inside from a front surface 12 (see FIG. 1) and a back surface layer 14 (see FIG. 1). Further, the tensile stress remaining in the intermediate layer is substantially constant.

In FIG. 5, S1 indicates a maximum residual compressive stress of the front surface layer, S2 indicates a maximum residual compressive stress of the back surface layer, D1 indicates a thickness of the front surface layer, D2 indicates a thickness of the back surface layer, D indicates a thickness of the glass plate 10, T indicates an average residual tensile stress of the intermediate layer, respectively. S1, S2 (S2=S1), D1, D2 (D2=D1), and T are strengthening conditions that can be adjusted. Further, S1, S2, D1, D2 can be measured by, for example, a commercially available surface stress meter. By assigning the measured results and D to the following expression (1), T can be calculated.

T=(S1×D1/2+S2×D2/2)/(D−D1−D2) (1)

Data measured with a microgauge or the like is used as D.

It is to be noted that the front and back surface layers of this embodiment have same maximum residual compressive stress and same thickness. However, the front and back surface layers may have different maximum residual compressive stress and different thickness.

It is to be noted that, although strengthened glass is used as the glass plate 10, there may be used a non-strengthened glass (T=0) on which no strengthening process is performed.

A float method, a fusion downdraw method, a slit downdraw method, or a redraw method may be used as a method for molding the glass plate 10.

The thickness of the glass plate 10 may be arbitrarily set according to usage or the like. For example, in a case where the usage is a substrate of a display, the thickness of the glass plate 10 is 30 μm to 1000 μm. Further, in a case where the usage is a cover glass of a display, the thickness of the glass plate 10 is 100 μm to 3000 μm.

No scribe line (groove line) extending along a predetermined cut line is formed beforehand on the front surface 12 of the glass plate 10. Although a scribe line may be formed beforehand, this would increase the number of steps. Further, the glass plate 10 may be chipped in a case where a scribe line is formed beforehand.

The term “predetermined cut line” refers to a virtual line that is predetermined to be a cut area on the front surface 12 of the glass plate 10. The shape of the predetermined cut line A is set according to purpose. For example, the predetermined cut line A may be set as a linear shape or a curved shape.

The start and end points of the predetermined cut line A may intersect with an outer peripheral part 16 of the glass plate 10. Further, the start and end points of the predetermined cut line A may be located within the outer peripheral part 16 of the glass plate 10. Further, the end point of the predetermined cut line A may intersect with a midsection of the same predetermined cut line A. In this case, the predetermined cut line A may have, for example, a P-letter shape. Further, a notch or an initial crack or the like may be the start point of the predetermined cut line A.

An initial crack, which serves as a start point for cutting, may be formed beforehand in the outer peripheral part 16 of the glass plate 10 according to the state of the outer peripheral part 16. As examples of a case of forming the initial crack beforehand, there is a case where the outer peripheral part 16 is strengthened or a case where the outer peripheral part 16 has no fine irregularities (e.g., micro-cracks).

The initial crack can be formed near the start point of the predetermined cut line A. The initial crack is formed by using common methods such as a cutter, a file, or a laser.

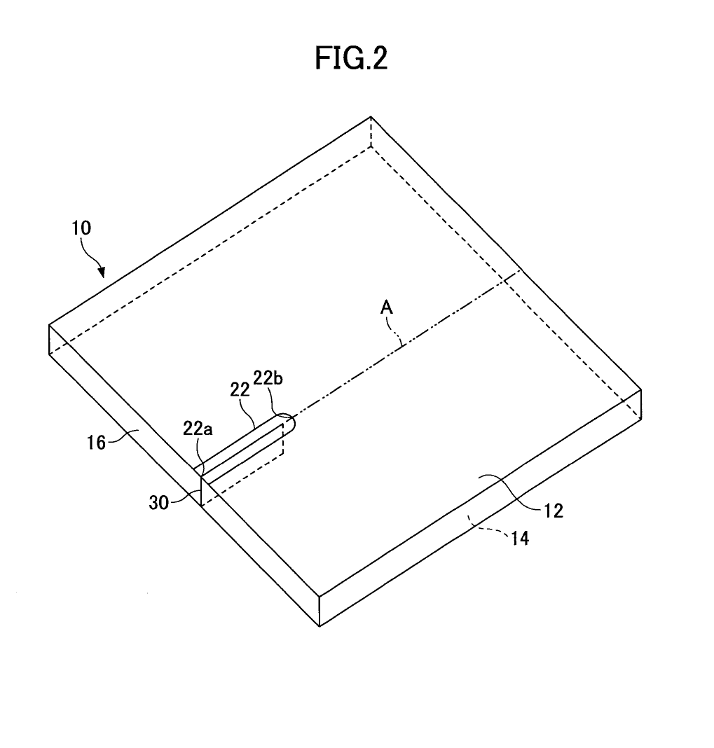

As illustrated in FIGS. 1-2, the method for cutting the glass plate 10 includes a first step of forming a crack 30 (see FIG. 2) in the glass plate 10 by radiating a laser beam 20 to the front surface 12 of the glass plate 10.

The laser beam 20 heats the glass plate 10 to a temperature of less than or equal to an annealing point, so that the crack 30 is generated by thermal stress. The crack 30 penetrates the glass plate 10 from the front surface 12 to the back surface 14. The temperature for heating the glass plate 10 is set to the temperature less than or equal to the annealing point, so as to prevent the viscosity property of the glass plate 10 from fluctuating.

The laser beam 20 has a wavelength of 5000 nm to 11000 nm. Because the wavelength is greater than or equal to 5000 nm, a large portion of the laser beam 20 is absorbed as heat at the front surface 12 of the glass plate 10. Thus, the laser beam 20 has satisfactory heating efficiency. There is no practical laser light source that provides the laser beam 20 with a wavelength surpassing 11000 nm. The wavelength of the laser beam 20 is preferably 5300 nm to 10800 nm, and more preferably, 9200 nm to 10600 nm.

The laser beam 20 is formed into a linear beam 22 at the front surface 12 of the glass plate 10. The following optical system may be used to form the laser beam 20 into the linear beam 22.

The linear beam 22 is formed into a shape conforming to the predetermined cut line A. For example, the linear beam 22 is formed in a straight line as illustrated in FIG. 1. It is to be noted that the shape of the linear beam 22 is not limited in particular and may be a curved line.

The linear beam 22 has a length L that is greater than or equal to 10 mm along the predetermined cut line A (see FIG. 1) and a width W that is less than or equal to 3 mm (see FIG. 1).

Because the length L is greater than or equal to 10 mm, a thermal stress that is symmetrical relative to the linear beam 22 is generated. The length L is preferably greater than or equal to 15 mm, and more preferably greater than or equal to 20 mm. It is to be noted that the length L is set to be less than or equal to the length of the predetermined cut line A.

Because the width W is less than or equal to 3 mm, an appropriate temperature gradient is generated in a direction orthogonal to the linear beam 22. The width W is preferably less than or equal to 2.5 mm, and more preferably less than or equal to 2 mm. Although the lower limit value of the width W is not limited in particular, the lower limit value of the width W may be 0.5 mm.

The linear beam 22 has a substantially uniform intensity distribution (energy density distribution) along the predetermined cut line A. The substantially uniform intensity distribution of the present invention means that the intensity (energy density) at both end parts 22a, 22b of the linear beam 22 has a steep distribution or a discontinuous distribution whereas the intensity at a center part of the linear beam 22 has a substantially uniform distribution. More specifically, assuming that the distance from a center of the linear beam 22 to both ends of the linear beam 22 is B (B=½L) and the maximum intensity in the linear beam 22 is C, the substantially uniform intensity distribution of the present invention means that the intensity at a region within 0.8×B from the center of the linear beam 22 to both ends of the linear beam 22 has a distribution within a range of 0.6×C to 1.0×C.

It is to be noted that the linear beam 22 may or may not have a substantially uniform intensity distribution in a direction orthogonal to the predetermined cut line A.

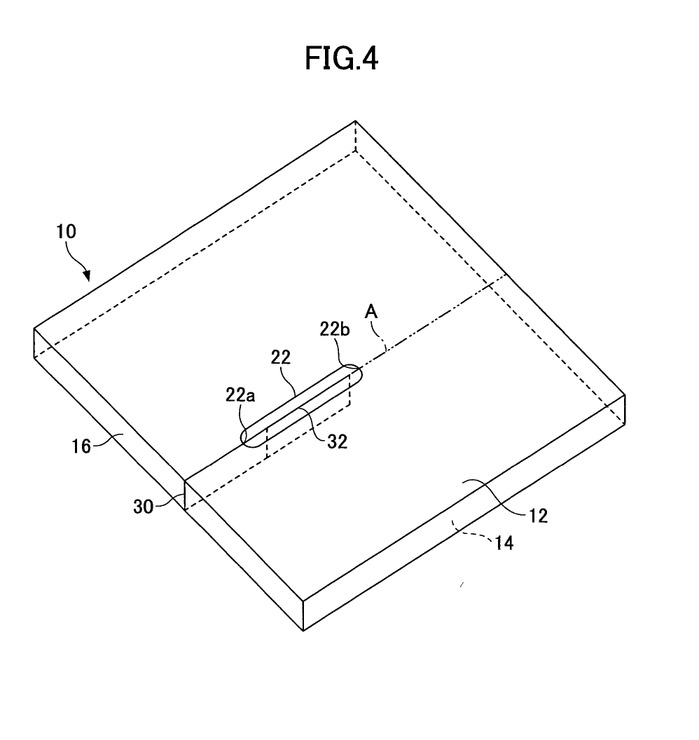

As illustrated in FIGS. 3-4, the method for cutting the glass plate 10 may further include a second step of forming a new crack 32 in the glass plate 10 by changing the position of the linear beam 22 and fixing the position of the linear beam 22 for a prescribed time.

The linear beam 22 heats the glass plate 10 to a temperature of less than or equal to an annealing point, so that a new crack 32 is generated by thermal stress. The crack 32 penetrates the glass plate 10 from the front surface 12 to the back surface 14. The temperature for heating the glass plate 10 is set to the temperature less than or equal to the annealing point, so as to prevent the viscosity property of the glass plate 10 from fluctuating.

The second step is effective when cutting the glass plate 10 having a large area and may be repetitively performed multiple times after the first step.

As long as the above-described conditions are satisfied in the second step, the dimension and the shape (including length L, width W) of the linear beam 22 may be changed between the first and the second steps. Further, in a case where the second step is repetitively performed multiple times, the dimension and the shape of the linear beam 22 may be changed during the middle of the second step.

Next, a method for cutting the glass plate 10 having a large area is described by also referring to FIGS. 1-4.

First, position alignment between a laser light source and the glass plate 10 is performed. Then, the output of the laser light source is increased to a prescribed value. The laser beam 20 is radiated to the front surface 12 of the glass plate 10 and becomes the linear beam 22 at the front surface 12. The linear beam 22 is formed into a shape conforming to the predetermined cut line A.

As illustrated in FIG. 1, one end part (rear end part) 22a of the linear beam 22 is located at the outer peripheral part 16 of the glass plate 10 in the first step. Because the outer peripheral part 16 of the glass plate 10 is a free end part that is free in an outward direction, the outer peripheral part 16 can easily be thermally expanded. On the other hand, another end part (front end part) 22b of the linear beam 22 is located more inward than the outer peripheral part 16 of the glass plate 10. Because the position of the linear beam 22 is fixed for a prescribed time, the temperature of the front surface of the glass plate 10 gradually increases at the position of the linear beam 22. In this case, at the other end part 22b of the linear beam 22, the glass plate 10 is prevented from thermally expanding, and the compressive stress of the glass plate gradually increases. On the other hand, at the one end part 22a of the linear beam 22, the tensile stress of the glass plate 10 gradually increases because the glass plate 10 can be easily thermally expanded.

Further, an end part of the glass plate 10 may be cooled by jetting a cooling medium to the one end part 22a of the linear beam 22. By cooling the end part of the glass plate 10, the tensile stress generated at the end part can be increased. It is to be noted that, although air or mist may be used as the cooling medium, the cooling medium is not to be limited in particular.

When the tensile stress generated at the end part of the glass plate 10 surpasses a threshold, the crack 30 is instantaneously generated in an inward direction from the outer peripheral part 16 of the glass plate 10. The crack 30 does not surpass the position of the other end part 22b of the linear beam 22 because compressive stress is generated at the position of the other end part 22b of the linear beam 22.

Further, expansion occurs in the front surface of the glass plate 10 because the temperature in the front surface of the glass plate 10 gradually increases at the position of the linear beam 22. As a result of this, the internal tensile stress of the glass plate 10 gradually increases immediately below the linear beam 22. The internal tensile stress of the glass plate 10 becomes substantially large before the crack 30 is generated.

Because the linear beam 22 has an intensity distribution that is substantially uniform along the predetermined cut line A (substantially uniform intensity distribution), the distribution of the internal tensile stress is formed substantially uniform along the predetermined cut line A. Thereby, the direction of propagation of the crack 30 can be guided along the linear beam 22, and the crack 30 can be prevented from deviating from the position of the linear beam 22.

Hence, according to this embodiment, the front surface temperature of the glass plate 10 gradually increases because the position of the linear beam 22 is fixed for a prescribed time in the first step. Thereby, the crack 30 can be prevented from surpassing the position of the other end part 22b of the linear beam 22.

In addition, according to this embodiment, the crack 30 can be prevented from deviating from the position of the linear beam 22 in the first step because the intensity distribution of the linear beam 22 is substantially uniform along the predetermined cut line A.

It is to be noted that the time for fixing the position of the linear beam 22 is set in accordance with, for example, the type of glass, the plate thickness, the intensity of the linear beam 22, or the type of the below-described optical system.

Then, the position of the linear beam 22 is changed. The change of the position of the linear beam 22 is implemented by relative movement of the glass plate 10 with respect to a laser light source. The movement may be performed by the glass plate 10 side, the laser light source side, or by both.

The output of the laser light source is set to a value that prevents a new crack 32 (see FIG. 4) from being generated during the change of the position of the linear beam 22. For example, the output of the laser light source may be set to 0 (W). If the time of movement is short, the output of the laser light source need not be changed.

As described above, the dimension and the shape (including length L, width W) of the linear beam 22 may be changed before or after changing the position of the linear beam 22. The change of the dimension and the shape of the linear beam 22 is effective in a case where the predetermined cut line A includes both a straight line part and a curved line part.

As illustrated in FIG. 3, the one end part 22a of the linear beam 22 is located at or near a distal end 30b of the crack 30 that was previously formed. The phrase “located at or near the distal end” refers to an area that is less than or equal to 5 mm from the distal end. It is to be noted that the one end part 22a of the linear beam 22 may be separated from the distal end 30b of the crack 30 as long as the one end part 22a is within the aforementioned range.

Because the glass plate 10 is open in a rearward direction at the distal end part 30b of the crack 30, the glass plate 10 can easily thermally expand at or near the distal end 30b of the crack 30. On the other hand, the other end part 22b of the linear beam 22 is separated from the distal end 30b of the crack 30 and the outer peripheral part 16 of the glass plate 10.

Because the position of the linear beam 22 is fixed for a prescribed time in the second step, the temperature of the front surface of the glass plate 10 gradually increases at the position of the linear beam 22. In this case, at the other end part 22b of the linear beam 22, the glass plate 10 is prevented from thermally expanding, and the compressive stress of the glass plate gradually increases. On the other hand, at the one end part 22a of the linear beam 22, the tensile stress of the glass plate 10 gradually increases because the glass plate 10 can be easily thermally expanded.

Further, a distal end of a previously formed crack or an end part of the glass plate near the distal end may be cooled by jetting a cooling medium to the one end part 22a of the linear beam 22. By cooling the end part of the glass plate 10, the tensile stress generated at the end part can be increased. It is to be noted that, although air or mist may be used as the cooling medium, the cooling medium is not to be limited in particular.

When the tensile stress generated at the end part of the glass plate 10 surpasses a threshold, the crack 32, which is newly formed from the distal end 30b of the crack 30, is instantaneously generated as illustrated in FIG. 4. The crack 32 does not surpass the position of the other end part 22b of the linear beam 22 because compressive stress is generated at the position of the other end part 22b of the linear beam 22.

Expansion occurs in the front surface of the glass plate 10 because the temperature in the front surface of the glass plate 10 gradually increases at the position of the linear beam 22. As a result of this, the internal tensile stress of the glass plate 10 gradually increases immediately below the linear beam 22. The internal tensile stress of the glass plate 10 becomes substantially large before the crack 32 is generated.

Because the linear beam 22 has an intensity distribution that is substantially uniform along the predetermined cut line A (substantially uniform intensity distribution), the distribution of the internal tensile stress is formed substantially uniform along the predetermined cut line A. Thereby, the direction of propagation of the crack 32 can be guided along the linear beam 22, and the crack 32 can be prevented from deviating from the position of the linear beam 22.

In order for the previously formed crack 30 and the currently formed crack 32 to be continuously connected to each other, the position of the other end part 22b of the beam 22 (before the change of position of the beam 22) preferably contacts or superposes the one end part 22a of the beam 22 (after the change of position of the beam 22), and more preferably superpose each other as illustrated in FIG. 3. Thereby, steps can be prevented from being formed in a cut surface.

The length X (see FIG. 3) of a superposition between the position of the linear beam 22 before being changed and the position of the linear beam 22 after being changed along the predetermined cut line A is arbitrarily set according to, for example, the length L of the linear beam 22. However, the length X of the superposition is preferably 2 mm to 5 mm.

It is to be noted that the time for fixing the position of the linear beam 22 in the second step is set in accordance with, for example, the type of the glass plate 10, the intensity of the linear beam 22, or the type of the below-described optical system.

It is to be noted that, in a case where the other end part 22b of the linear beam 22 is located at the outer peripheral part 16 of the glass plate 10 in the second step, the glass plate 10 can be easily thermally expanded at both end parts 22a, 22b of the linear beam 22. Thereby, the tensile stress of the glass plate 10 gradually increases. The crack 32, extending from one to another end of the end parts 22a, 22b of the linear beam 22, is instantaneously formed when the tensile stress of the glass plate 10 surpasses a threshold.

Next, a method for cutting the glass plate 10 having a large area is described. In the following, there is described a case where the start and end points of the predetermined cut line A is located at the outer peripheral part 16 of the glass plate 10, and both end parts 22a, 22b of the linear beam 22 are located at the outer peripheral part 16 of the glass plate 10. However, it is also the same where the end point of the predetermined cut line A intersects with the midsection of the same predetermined cut line A.

The temperature of the front surface of the glass plate 10 gradually increases at the position of the linear beam 22. In this case, the tensile stress generated at an end part of the glass plate 10 gradually increases because the glass plate 10 can be easily thermally expanded at the positions of both end parts 22a, 22b of the linear beam 22. The crack 30 is generated from the outer peripheral part 16 of the glass plate 10 when the tensile stress of the glass plate 10 surpasses a threshold. The crack 30, extending from one to another end of the end parts 22a, 22b of the linear beam 22, is instantaneously formed.

Further, expansion occurs in the front surface of the glass plate 10 because the temperature in the front surface of the glass plate 10 gradually increases at the position of the linear beam 22. As a result of this, the internal tensile stress of the glass plate 10 gradually increases immediately below the linear beam 22. The internal tensile stress of the glass plate 10 becomes substantially large before the crack 30 is generated.

According to this embodiment, the distribution of the internal tensile stress is formed substantially uniform along the predetermined cut line A because the linear beam 22 has an intensity distribution that is substantially uniform along the predetermined cut line A. Thereby, the direction of propagation of the crack 30 can be guided along the linear beam 22, and the crack 30 can be prevented from deviating from the position of the linear beam 22.

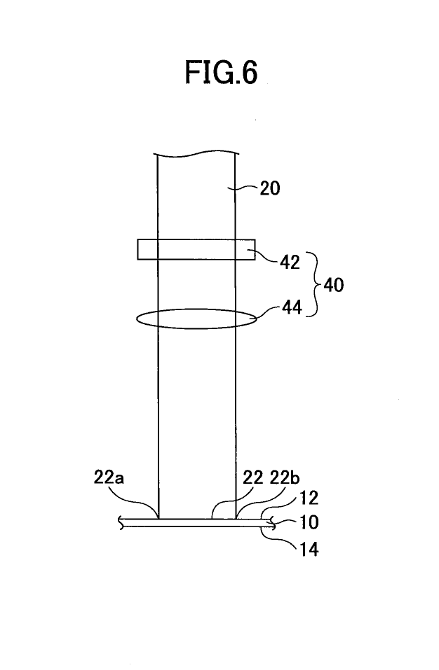

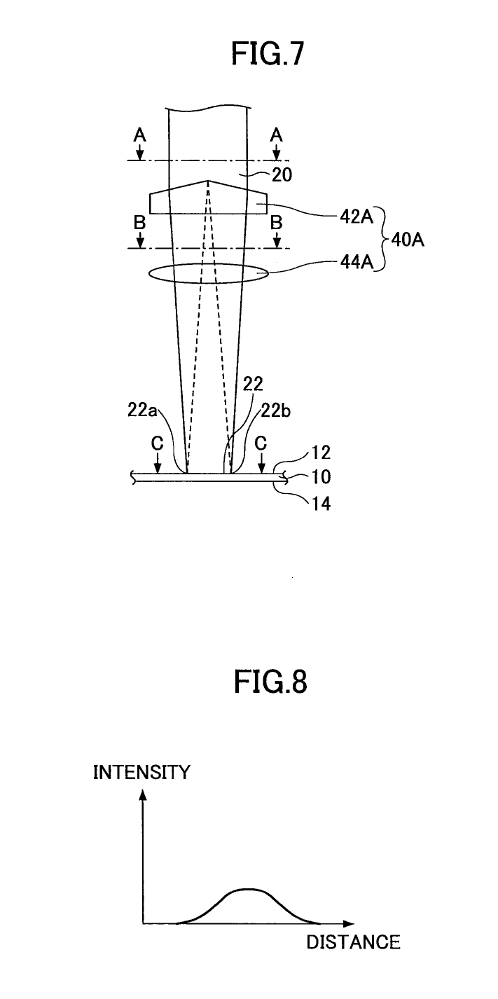

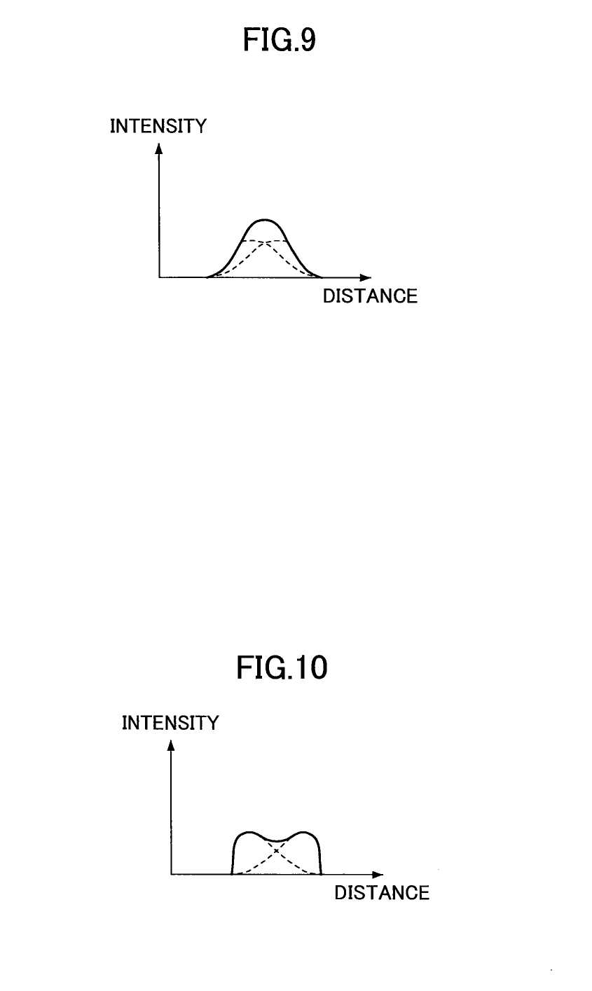

FIGS. 6-7 and 11-12 are explanatory views of an optical system provided between a laser light source and a front surface of a glass plate. FIG. 8 is a diagram illustrating a distribution of intensity of a laser beam at a position along line A-A of FIG. 7. FIG. 9 is a diagram illustrating a distribution of intensity of a laser beam at a position along line B-B of FIG. 7. FIG. 10 is a diagram illustrating a distribution of intensity of a laser beam at a position along line C-C of FIG. 7.

The optical systems 40-40C illustrated in FIGS. 6-7 and 11-12 form the laser beam 20 radiated from a laser source into the linear beam 22 at the front surface 12 of the glass plate 10, respectively.

The optical system 40 illustrated in FIG. 6 includes a homogenizer 42 and a cylindrical lens 44. The homogenizer 42 changes the distribution of the intensity of the laser beam 20 from a Gaussian distribution to a top hat distribution by allowing the laser beam 20 radiated from the laser source to transmit therethrough. The cylindrical lens 44 converges the laser beam transmitted through the homogenizer 42 in a prescribed direction (direction orthogonal to the paper surface in FIG. 6), so that the linear beam 22 forms an image on the front surface 12 of the glass plate 10. The linear beam 22 may be formed in, for example, a straight line and have a substantially uniform intensity distribution in a longitudinal direction.

The optical system 40A illustrated in FIG. 7 includes a prism 42A and a cylindrical lens 44A. The prism 42A not only divides the laser beam 20 into two by allowing the laser beam 20 radiated from the laser source to transmit therethrough but also changes the direction of the optical path of the laser beam 20, so that the divided two lights are superposed at the front surface 12 of the glass plate 10. The cylindrical lens 44A converges each of the two lights divided by the prism 42A into a prescribed direction (direction orthogonal to the paper surface in FIG. 7), so that the linear beam 22 forms an image on the front surface 12 of the glass plate 10. The linear beam 22 may be formed in, for example, a straight line and have a substantially uniform intensity distribution in a longitudinal direction.

In the optical system 40A illustrated in FIG. 7, the distribution of the intensity of the laser beam 20 changes as illustrated in FIGS. 8-10. The distribution of the intensity of the laser beam 20 changes from Gaussian distribution of FIG. 8 to a distribution illustrated with a solid line in FIG. 9 by allowing the laser beam 20 to transmit through the prism 42A. The distribution illustrated with the solid line in FIG. 9 is a distribution formed by partly superposing left and right halves of the Gaussian distribution illustrated with dotted lines in FIG. 9. As illustrated with a dotted line of FIG. 10, the left and right halves of the Gaussian distribution are superposed at the front surface 12 of the glass plate 10, so that the distribution of the intensity of the laser beam 20 at the front surface 12 of the glass plate 10 becomes a substantially uniform distribution illustrated with a solid line in FIG. 10.

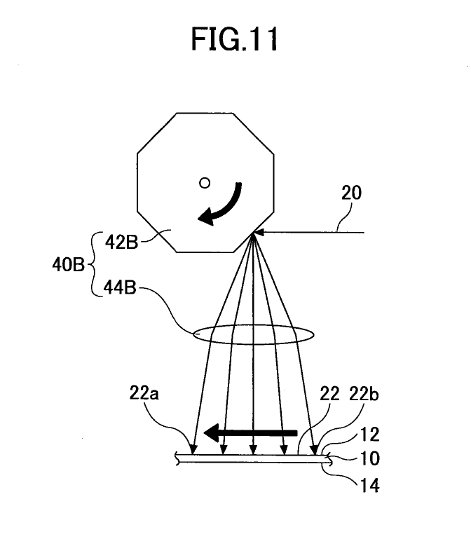

The optical system 40B illustrated in FIG. 11 includes a polygon mirror 42B and a fθ lens 44B. The polygon mirror 42B reflects the laser beam 20 radiated from the light source. The fθ lens 44B allows the laser beam reflected from the polygon mirror 42B to transmit therethrough, so that a spot beam forms an image on the front surface 12 of the glass plate 10.

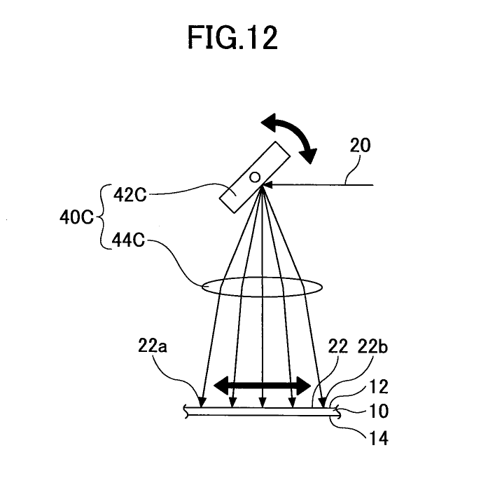

The spot beam is formed in, for example, a circular shape and has a diameter of 1 mm to 3 mm. The distribution of the intensity of the spot beam may be a Gaussian distribution or a top hat distribution. The spot beam becomes the linear beam 22 that scans between prescribed two points on the predetermined cut line A for multiple times and has a substantially uniform distribution in a scanning direction. The scanning rate of the spot beam may be, for example, 100 mm/sec to 10000 mm/sec. The number of times of scanning the spot beam may be, for example, 10 times to 1000 times. The optical system 40C illustrated in FIG. 12 includes a Galvano mirror 42C and an fθ lens 44C. The Galvano mirror 42C reflects the laser beam 20 radiated from the light source. The fθ lens 44C allows the laser beam 20 reflected from the Galvano mirror 42C to transmit therethrough, so that a spot beam forms an image on the front surface 12 of the glass plate 10.

The spot beam is formed in, for example, a circular shape and has a diameter of 1 mm to 3 mm. The distribution of the intensity of the spot beam may be a Gaussian distribution or a top hat distribution. The spot beam becomes the linear beam 22 that scans between prescribed two points on the predetermined cut line A for multiple times by oscillating the Galvano mirror 42C and has a substantially uniform distribution in a scanning direction. The scanning rate of the spot beam may be, for example, 100 mm/sec to 10000 mm/sec. The number of times of scanning the spot beam may be, for example, 10 times to 1000 times.

A Galvano scanner includes the optical system 40C and a motor that oscillates the Galvano mirror. The Galvano scanner 42C may include multiple Galvano mirrors 42C. In this case, the spot beam can scan two-dimensionally and change the shape of the linear beam 22.

The optical systems 40-40C illustrated in FIGS. 6-7 and FIGS. 11-12 may used differently according to, for example, the type of laser light source or the configuration of the predetermined cut line A. For example, in a case where the type of laser light source is a pulse laser that intermittently oscillates the laser beam 20, it is preferable to use the optical system 40 (see FIG. 6) or the optical system 40A (see FIG. 7) so that the distribution of the intensity of the linear beam 22 becomes substantially uniform along the predetermined cut line A. Further, in a case where the predetermined cut line A includes a straight line part and a curved line part, it is preferable to use the Galvano scanner capable of scanning the spot beam two-dimensionally for changing the shape of the linear beam 22.

### WORKING EXAMPLES

### Examples 1-11

### (Test Plate)

In examples 1-4, soda-lime glass were used as test plates for cutting. The compositions of the test plates in examples 1-4 were the same. The thicknesses of the test plates in examples 1-4 are as shown in Table 1.

In examples 5-11, chemically strengthened glass were used as test plates for cutting. The compositions of the test plates in examples 5-11 were the same. The thicknesses of the test plates in examples 1-4 are as shown in Table 1.

The average residual tensile stress of the intermediate layer of the chemically strengthened glass was calculated by assigning results measured with, for example, a surface stress meter (FSM-6000, Orihara Industrial Co. Ltd.) to the above-described expression (1). The calculated values are shown in Table 1. It is to be noted that, as a result of the measurement with the surface stress meter, the front surface layer and the back surface layer had the same maximum residual compressive stress and the same thickness.

### (Cutting of Test Plate)

In examples 1-9 (working examples), partial cutting was performed on the test plates by using, as a laser light source, a carbon dioxide gas laser (main wavelength: 10600 nm) that continuously oscillates a laser beam along with using, as an optical system, the optical system 40A illustrated in FIG. 7. The linear beam at the front surface of the test plate had a straight line shape with a length of 30 mm and a width of 2 mm, and the distribution of the intensity of the linear beam was substantially uniform along the predetermined cut line. Without performing any change of position of the linear beam, the linear beam was formed extending in a vertical direction from an outer periphery of the test plate. The output of the laser light source and the radiation time of the laser beam are shown in Table 1.

Meanwhile, in example 10 (comparative example), the cutting of the test plate was performed in the same manner as the examples 1-9 except that the prism 42A was not used in the optical system 40A illustrated in FIG. 7. Because there is no prism 42A that divides the laser beam into two, the linear beam at the front surface of the test plate had a straight line shape with a length of 60 mm and a width of 2 mm, and the distribution of the intensity of the linear beam was a Gaussian distribution. Without performing any change of position of the linear beam, the linear beam was formed extending in a vertical direction from an outer periphery of the test plate. The output of the laser light source and the radiation time of the laser beam are shown in Table 1.

Further, in example 11 (comparative example), the cutting of the test plate was performed in the same manner as example 9 except that the position of the linear beam was continuously moved. The linear beam had a straight line shape with a length of 30 mm and a width of 2 mm, and the distribution of the intensity of the linear beam was substantially uniform. Immediately after forming the linear beam extending in a vertical direction from the outer periphery of the test plate, the linear beam was moved 100 mm in the vertical direction at a rate of 10 mm/sec. The output of the laser light source is shown in Table 1.

### (Evaluation of Cutting)

The state of cracks generated during cutting was visually evaluated. Cracks were generated at a radiation position of the linear beam. The cracks having straight line shapes are marked with a “◯”, and the cracks propagating beyond the radiation position of the linear beam and deviating from the predetermined cut line are marked with an “×”. In the example 10, cracks deviated from the predetermined cut line at an area located inward from the outer periphery of the test plate. In the example 11, cracks deviated from the predetermined cut line at the outer periphery of the test plate. Results of the evaluation are shown in Table 1.

TABLE 1

| | | | AVERAGE | | | OUTPUT | | |
|---|---|---|---|---|---|---|---|---|
| | | | RESIDUAL | LINEAR | INTENSITY | OF LASER | | |
| | | PLATE | TENSILE | BEAM | DISTRIBUTION | LIGHT | RADIATION | |
| | TYPE OF | THICKNESS | STRESS | W × L | OF LINEAR | SOURCE | TIME | |
| | GLASS | (mm) | (MPa) | (mm) | BEAM | (W) | (sec) | RESULTS |
| EXAMPLE 1 | SODA-LIME GLASS | 0.55 | 0 | 2 × 30 | SUBSTANTIALLY | 40 | 2 | ◯ |
| | | | | | UNIFORM | | | |
| EXAMPLE 2 | SODA-LIME GLASS | 0.55 | 0 | 2 × 30 | SUBSTANTIALLY | 25 | 4 | ◯ |
| | | | | | UNIFORM | | | |
| EXAMPLE 3 | SODA-LIME GLASS | 1 | 0 | 2 × 30 | SUBSTANTIALLY | 50 | 2 | ◯ |
| | | | | | UNIFORM | | | |
| EXAMPLE 4 | SODA-LIME GLASS | 1 | 0 | 2 × 30 | SUBSTANTIALLY | 30 | 4 | ◯ |
| | | | | | UNIFORM | | | |
| EXAMPLE 5 | CHEMICALLY | 0.9 | 18.1 | 2 × 30 | SUBSTANTIALLY | 30 | 4 | ◯ |
| | STRENGTHENED | | | | UNIFORM | | | |
| | GLASS | | | | | | | |
| EXAMPLE 6 | CHEMICALLY | 0.9 | 25.2 | 2 × 30 | SUBSTANTIALLY | 35 | 4 | ◯ |
| | STRENGTHENED | | | | UNIFORM | | | |
| | GLASS | | | | | | | |
| EXAMPLE 7 | CHEMICALLY | 0.5 | 28.1 | 2 × 30 | SUBSTANTIALLY | 25 | 4 | ◯ |
| | STRENGTHENED | | | | UNIFORM | | | |
| | GLASS | | | | | | | |
| EXAMPLE 8 | CHEMICALLY | 0.9 | 35.7 | 2 × 30 | SUBSTANTIALLY | 40 | 4 | ◯ |
| | STRENGTHENED | | | | UNIFORM | | | |
| | GLASS | | | | | | | |
| EXAMPLE 9 | CHEMICALLY | 0.5 | 46.7 | 2 × 30 | SUBSTANTIALLY | 25 | 4 | ◯ |
| | STRENGTHENED | | | | UNIFORM | | | |
| | GLASS | | | | | | | |
| EXAMPLE | CHEMICALLY | 0.5 | 46.7 | 2 × 60 | GAUSSIAN | 100 | 2 | X |
| 10 | STRENGTHENED | | | | | | | |
| | GLASS | | | | | | | |
| EXAMPLE | CHEMICALLY | 0.5 | 46.7 | 2 × 30 | GAUSSIAN | 30 | — | X |
| 11 | STRENGTHENED | | | | | | | |
| | GLASS | | | | | | | |

According to Table 1, it can be understood that satisfactory generation of cracks and satisfactory cutting precision can be achieved for both strengthened glass and non-strengthened glass by attaining a linear beam having a substantially uniform intensity distribution in a longitudinal direction (cutting direction) and fixing the position of the linear beam for a prescribed time.

### Examples 12-16

### (Test Plate)

In example 12, soda-lime glass having the same composition as that of example 1 was prepared as the test plate for cutting. The thickness of the test plate of example 12 is as shown in Table 2.

In examples 13-16, chemically strengthened glass were used as test plates for cutting. The composition of the test plates in examples 13-16 were the same as that of the test plate of example 5 before being chemically strengthened. The thicknesses of the test plates in examples 13-16 are as shown in Table 2.

The average residual tensile stress of the intermediate layer of the chemically strengthened glass was calculated by assigning results measured with, for example, a surface stress meter (FSM-6000, Orihara Industrial Co. Ltd.) to the above-described expression (1). The calculated values are shown in Table 2. It is to be noted that, as a result of the measurement with the surface stress meter, the front surface layer and the back surface layer had the same maximum residual compressive stress and the same thickness.

### (Cutting of Test Plate)

In examples 12-16, partial cutting was performed on the test plates by using, as a laser light source, a carbon dioxide gas laser (main wavelength: 10600 nm) that continuously oscillates a laser beam along with using, as an optical system, the optical system 40C (Galvano scanner) illustrated in FIG. 12.

The spot beam at the front surface of the test plate had a circular shape with a diameter of 2 mm. The spot beam was scanned between prescribed two points on the predetermined cut line for multiple times and became a linear beam having a straight line shape with a width of 2 mm. The distance of a single scan (distance between the prescribed two points), the scan rate, the output of the laser light source, and the number of times of scanning are shown in Table 2. Without performing any change of position of the linear beam, the linear beam was formed extending in a vertical direction from an outer periphery of the test plate.

### (Evaluation of Cutting)

The state of cracks generated during cutting was visually evaluated in the same manner as examples 1-11. Results of the evaluation are shown in Table 2.

TABLE 2

| | | | AVERAGE | | | OUTPUT | | |
|---|---|---|---|---|---|---|---|---|
| | | | RESIDUAL | | | OF LASER | NUMBER | |
| | | PLATE | TENSILE | SCAN | SCAN | LIGHT | OF TIMES OF | |
| | TYPE OF | THICKNESS | STRESS | DISTANCE | RATE | SOURCE | SCANING | |
| | GLASS | (mm) | (MPa) | (mm) | (mm/sec) | (W) | (TIMES) | RESULTS |
| EXAMPLE | SODA-LIME GLASS | 0.55 | 0 | 30 | 1200 | 27 | 100 | ◯ |
| 12 | | | | | | | | |
| EXAMPLE | CHEMICALLY | 0.9 | 18.6 | 30 | 1200 | 30 | 100 | ◯ |
| 13 | STRENGTHENED GLASS | | | | | | | |
| EXAMPLE | CHEMICALLY | 0.9 | 25.2 | 20 | 1200 | 30 | 100 | ◯ |
| 14 | STRENGTHENED GLASS | | | | | | | |
| EXAMPLE | CHEMICALLY | 0.5 | 28.1 | 30 | 1200 | 24 | 100 | ◯ |
| 15 | STRENGTHENED GLASS | | | | | | | |
| EXAMPLE | CHEMICALLY | 0.5 | 46.7 | 30 | 1200 | 24 | 100 | ◯ |
| 16 | STRENGTHENED GLASS | | | | | | | |

According to Table 2, it can be understood that satisfactory generation of cracks and satisfactory cutting precision can be achieved for both strengthened glass and non-strengthened glass by a linear beam attained by scanning a spot beam multiple times.

### Examples 17-22

### (Test Plate)

In example 17, soda-lime glass having the same composition as that of example 1 was prepared as the test plate for cutting. The thickness of the test plate of example 17 is as shown in Table 3.

In examples 18-22, chemically strengthened glass were used as test plates for cutting. The composition of the test plates in examples 18-22 were the same as that of the test plate of example 5 before being chemically strengthened. The thicknesses of the test plates in examples 18-22 are as shown in Table 3.

The average residual tensile stress of the intermediate layer of the chemically strengthened glass was calculated by assigning results measured with, for example, a surface stress meter (FSM-6000, Orihara Industrial Co. Ltd.) to the above-described expression (1). The calculated values are shown in Table 3. It is to be noted that, as a result of the measurement with the surface stress meter, the front surface layer and the back surface layer had the same maximum residual compressive stress and the same thickness.

### (Cutting of Test Plate)

In examples 17-22, cutting was performed on the test plates by using, as a laser light source, a carbon dioxide gas laser (main wavelength: 10600 nm) along with using, as an optical system, the optical system 40C (Galvano scanner) illustrated in FIG. 12.

The spot beam at the front surface of the test plate had a circular shape with a diameter of 2 mm. The spot beam was scanned on the predetermined cut line on the same plane as the front surface of the test plate and also between prescribed two points on the predetermined cut line for multiple times, to thereby become a linear beam having a straight line shape with a width of 2 mm. The distance of a single scan (distance between the prescribed two points), the scan rate, the output of the laser light source, and the number of times of scanning are shown in Table 3. After the linear beam is formed extending in a vertical direction from an outer periphery of the test plate, the linear beam has its position repetitively changed in the vertical direction and is radiated multiple times. Before and after the changing of positions, the position of the one end part of the linear beam before being changed is superposed with the position of the other end part of the linear beam after being changed. During the period of changing the positions of the linear beam, the output of the laser light source is constant and is the same value as the value when the position of the linear beam is fixed.

It is to be noted that, because the spot beam is scanned to include an area beyond the test plate, the linear beams formed on the test plate for the first and the last time have lengths shorter than the scanning distance illustrated in Table 3 (but greater than or equal to 10 mm). Except for the linear beams formed for the first and the last time, the linear beams had the same lengths as the scanning distances illustrated in Table 3.

### (Evaluation of Cutting)

The state of cracks generated during cutting was visually evaluated in the same manner as examples 1-11. Results of the evaluation are shown in Table 3.

TABLE 3

| | | | | | | OUTPUT | | NUMBER | | LENGTH | |
|---|---|---|---|---|---|---|---|---|---|---|---|
| | | | AVERAGE | | | OF | NUMBER | OF TIMES | SUPER- | OF PRE- | |
| | | PLATE | RESIDUAL | SCAN | SCAN | LASER | OF TIMES | OF LINEAR | POSI- | DETER- | |
| | | THICK- | TENSILE | DIS- | RATE | LIGHT | OF | BEAM | TION | MINED | |
| | TYPE OF | NESS | STRESS | TANCE | (mm/ | SOURCE | SCANNING | RADIA- | LENGTH | CUT LINE | RE- |
| | GLASS | (mm) | (MPa) | (mm) | sec) | (W) | (TIMES) | TION | (mm) | (mm) | SULTS |
| EXAM- | SODA-LIME | 0.55 | 0 | 30 | 1200 | 27 | 100 | 4 | 2 | 100 | ◯ |
| PLE 17 | GLASS | | | | | | | | | | |
| EXAM- | CHEMICALLY | 0.9 | 18.6 | 15 | 1200 | 24 | 80 | 5 | 2 | 60 | ◯ |
| PLE 18 | STRENGTHENED | | | | | | | | | | |
| | GLASS | | | | | | | | | | |
| EXAM- | CHEMICALLY | 0.9 | 29.3 | 15 | 1200 | 27 | 80 | 5 | 2 | 60 | ◯ |
| PLE 19 | STRENGTHENED | | | | | | | | | | |
| | GLASS | | | | | | | | | | |
| EXAM- | CHEMICALLY | 0.5 | 34.8 | 20 | 1200 | 24 | 80 | 4 | 5 | 60 | ◯ |
| PLE 20 | STRENGTHENED | | | | | | | | | | |
| | GLASS | | | | | | | | | | |
| EXAM- | CHEMICALLY | 0.9 | 39.0 | 15 | 1200 | 24 | 80 | 5 | 2 | 60 | ◯ |
| PLE 21 | STRENGTHENED | | | | | | | | | | |
| | GLASS | | | | | | | | | | |
| EXAM- | CHEMICALLY | 0.5 | 46.7 | 20 | 1200 | 24 | 60 | 4 | 5 | 60 | ◯ |
| PLE 22 | STRENGTHENED | | | | | | | | | | |
| | GLASS | | | | | | | | | | |

According to Table 3, it can be understood that satisfactory generation of cracks and satisfactory cutting precision can be achieved for both strengthened glass and non-strengthened glass even in a case where the position of the linear beam is changed. It can also be understood that, during the period of changing the positions of the linear beam, the output of the laser light source may be constant and the value of the output of the laser light source may be the same as the value when the position of the linear beam is fixed.

Hence, although embodiments of a method for cutting a glass plate have been described above, the present invention is not limited to these embodiments, but variations and modifications may be made without departing from the scope of the present invention.

### DESCRIPTION OF THE REFERENCE NUMERALS

10 glass plate
12 front surface
14 back surface
16 outer peripheral part
20 laser beam
22 linear beam
22a one end part
22b other end part
30 crack
30a distal end
32 crack
40C optical system of Galvano scanner
42C Galvano mirror
44C fθ lens

1. A method for cutting a glass plate including a first step of radiating a laser beam onto a front surface of the glass plate and forming a crack in the glass plate, the method characterized by:
the laser beam having a wavelength of 5000-11000 nm and becoming a linear beam at the front surface of the glass plate; and
the linear beam being formed into a shape conforming to a predetermined cut line, having a length greater than or equal to 10 mm along the predetermined cut line and a width less than or equal to 3 mm, and having an intensity distribution that is substantially uniform along the predetermined cut line;
wherein in the first step, a position of the linear beam in the front surface of the glass plate is fixed for a prescribed time, and at least one end part of the linear beam is located at an outer peripheral part of the glass plate.

2. The method for cutting a glass plate as claimed in claim 1, further including a second step of forming a new crack in the glass plate by changing the position of the linear beam and fixing the position of the linear beam for a prescribed time;
wherein in the second step, the one end part of the linear beam is located at a distal end of a previously formed crack or near the distal end.

3. The method for cutting a glass plate as claimed in claim 2, wherein before and after the position of the linear beam is changed, a position of the one end part of the linear beam after being changed contacts or superposes a position of the other end part of the linear beam before being changed.

4. The method for cutting a glass plate as claimed in claim 1, wherein the laser beam radiated from a laser light source is formed into the linear beam at the front surface of the glass plate by a Galvano scanner.

5. The method for cutting a glass plate as claimed in claim 1, wherein the glass plate is cooled by jetting a cooling medium to the one end part of the linear beam.
